(19) United States
(12) Patent Application Publication
(10) Pub. No.: US 2004/0078191 A1
(43) Pub. Date: Apr. 22, 2004

(54) Scalable neural network-based language identification from written text

(75) Inventors: Jilei Tian, Tampere (FI); Janne Suontausta, Tampere (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/279,747

(22) Filed: Oct. 22, 2002

(51) Int. Cl. G06F 17/27

(52) U.S. Cl. 704/9

(57) ABSTRACT

A method for language identification from written text, wherein a neural network-based language identification system is used to identify the language of a string of alphabet characters among a plurality of languages. A standard set of alphabet characters is used for mapping the string into a mapped string of alphabet characters so as to allow the NN-LID system to determine the likelihood of the mapped string being one of languages based on the standard set. The characters of the standard set are selected from the alphabet characters of the language-dependent sets. A scoring system is also used to determine the likelihood of the string being each one of the languages based on the language-dependent sets.

### FIELD OF THE INVENTION

The present invention relates generally to a method and system for identifying a language given one or more words, such as names in the phonebook of a mobile device, and to a multilingual speech recognition system for voice-driven name dialing or command control applications.

### BACKGROUND OF THE INVENTION

A phonebook or contact list in a mobile phone can have names of contacts written in different languages. For example, names such as “Smith”, “Poulenc”, “Szabolcs”, “Mishima” and “Maalismaa” are likely to be of English, French, Hungarian, Japanese and Finnish origin, respectively. It is advantageous or necessary to recognize in what language group or language the contact in the phonebook belongs.

Currently, Automatic Speech Recognition (ASR) technologies have been adopted in mobile phones and other hand-held communication devices. A speaker-trained name dialer is probably one of the most widely distributed ASR applications. In the speaker-trained name dialer, the user has to train the models for recognition, and it is known as the speaker dependent name dialing (SDND). Applications that rely on more advanced technology do not require the user to train any models for recognition. Instead, the recognition models are automatically generated based on the orthography of the multi-lingual words. Pronunciation modeling based on orthography of the multi-lingual words is used, for example, in the Multilingual Speaker-Independent Name Dialing (ML-SIND) system, as disclosed in Viikki et al. (“Speaker- and Language-Independent Speech Recognition in Mobile Communication Systems”, in Proceedings of International Conference on Acoustics, Speech, and Signal Processing, Salt Lake City, Utah, USA 2002). Due to globalization as well as the international nature of the markets and future applications in mobile phones, the demand for multilingual speech recognition systems is growing rapidly. Automatic language identification is an integral part of multilingual systems that use dynamic vocabularies. In general, a multilingual speech recognition engine consists of three key modules: an automatic language identification (LID) module, an on-line language-specific text-to-phoneme modeling (TTP) module, and a multilingual acoustic modeling module, as shown in FIG. 1. The present invention relates to the first module.

When a user adds a new word or a set of words to the active vocabulary, language tags are first assigned to each word by the LID module. Based on the language tags, the appropriate language-specific TTP models are applied in order to generate the multi-lingual phoneme sequences associated with the written form of the vocabulary item. Finally, the recognition model for each vocabulary entry is constructed by concatenating the multi-lingual acoustic models according to the phonetic transcription.

Automatic LID can be divided into two classes: speech-based and text-based LID, i.e., language identification from speech or written text. Most speech-based LID methods use a phonotactic approach, where the sequence of phonemes associated with the utterance is first recognized from the speech signal using standard speech recognition methods. These phonemes sequences are then rescored by language-specific statistical models, such as n-grams. The n-gram and spoken word information based automatic language identification has been disclosed in Schulze (EP 2 014 276 A2), for example.

By assuming that language identity can be discriminated by the characteristics of the phoneme sequences patterns, rescoring will yield the highest score for the correct language. Language identification from text is commonly solved by gathering language specific n-gram statistics for letters in the context of other letters. Such an approach has been disclosed in Schmitt (U.S. Pat. No. 5,062,143).

While the n-gram based approach works quite well for fairly large amounts of input text (e.g., 10 words or more), it tends to break down for very short segments of text. This is especially true if the n-grams are collected from common words and then are applied to identifying the language tag of a proper name. Proper names have very a typical grapheme statistics compared to common words as they are often originated from different languages. For short segments of text, other methods for LID might be more suitable. For example, Kuhn et al. (U.S. Pat. No. 6,016,471) discloses a method and apparatus using decision trees to generate and score multiple pronunciations for a spelled word.

Decision trees have been successfully applied to text-to-phoneme mapping and language identification. Similar to the neural network approach, decision trees can be used to determine the language tag for each of the letters in a word. Unlike the neural network approach, there is one decision tree for each of the different characters in the alphabets. Although decision tree-based LID performs very well for trained set, it does not work as well for validation set. Decision tree-based LID also requires more memory.

A simple neural network architecture that has successfully been applied to text-to-phoneme mapping task is the multi-layer perceptron (MLP). As TTP and LID are similar tasks, this architecture is also well suited for LID. The MLP is composed of layers of units (neurons) arranged so that information flows from the input layer to the output layer of the network. The basic neural network-based LID model is a standard two-layer MLP, as shown in FIG. 2. In the MLP network, letters are presented one at a time in a sequential manner, and the network gives estimates of language posterior probabilities for each presented letter. In order to take the grapheme context into account, letters on each side of the letter in question can also be used as input to the network. Thus, a window of letters is presented to the neural network as input. FIG. 2 shows a typical MLP with a context size of four letters l₄ . . . l₄ on both sides of the current letter l₀. The centermost letter l₀ is the letter that corresponds to the outputs of the network. Thus, the outputs of the MLP are the estimated language probabilities for the centermost letter l₀ in the given context l₄ . . . l₄. A graphemic null is defined in the character set and is used for representing letters to the left of the first letter and to the right of the last letter in a word.

Because the neural network input units are continuously valued, the letters in the input window need to be transformed to some numeric quantities or representations. An example of an orthogonal code-book representing the alphabet used for language identification is shown in TABLE I. The last row in TABLE I is the code for the graphemic null. The orthogonal code has a size equal to the number of letters in an alphabet set. An important property of the orthogonal coding scheme is that it does not introduce any correlation between different letters.

TABLE 1
Orthogonal letter coding scheme.

| Letter | Code |
|---|---|
| a | 100 . . . 0000 |
| b | 010 . . . 0000 |
| . | . |
| . | . |
| . | . |
| ñ | 000 . . . 1000 |
| ä | 000 . . . 0100 |
| ö | 000 . . . 0010 |
| # | 000 . . . 0001 |

In addition to the orthogonal letter coding scheme, as listed in TABLE I, other methods can also be used. For example, a self-organizing codebook can be utilized, as presented in Jensen and Riis (“Self-organizing Letter Code-book for Text-to-phoneme Neural Network Model”, in Proceedings of International Conference on Spoken Language Processing, Beijing, China, 2000). When the self-organizing codebook is utilized, the coding method for the letter coding scheme is constructed on the training data of the MLP. By utilizing the self-organizing codebook, the number of input units of the MLP can be reduced, therefore the memory required for storing the parameters of the network is reduced.

In general, the memory size in bytes required by the NN-LID model is directly proportional to the following quantities:

MemS=(2*ContS+1)×AlphaS×HiddenU+(HiddenU×LangS) (1)

where MemS, ContS, AlphaS, Hidden U and LangS stand for the memory size of LID, context size, size of alphabet set, number of hidden units in the neural network and the number of languages supported by LID, respectively. The letters of the input window are coded, and the coded input is fed into the neural network. The output units of the neural network correspond to the languages. Softmax normalization is applied at the output layer, and the value of an output unit is the posterior probability for the corresponding language. Softmax normalization ensures that the network outputs are in the range [0,1] and the sum of all network outputs is equal to unity according to the following equation.

$${P}_{i} = \frac{{ⅇ}^{{y}_{ⅈ}}}{{\sum }_{j = 1}^{C} {ⅇ}^{{y}_{j}}} ,$$

In the above equation, yᵢ and Pᵢ denote the i^{th} output value before and after softmax normalization. C is the number of units in output layer, representing the number of classes, or targeted languages. The outputs of a neural network with softmax normalization will approximate class posterior probabilities when trained for 1 out of N classifications and when the network is sufficiently complex and trained to a global minimum.

The probabilities of the languages are computed for each letter. After the probabilities have been calculated, the language scores are obtained by combining the probabilities of the letters in the word. In sum, the language in an NN-based LID is mainly determined by

$$\begin{matrix}{lang}^{*} = {arg max }_{i} P ( {lang}_{i} \vert word ) & apply Bayesian rule \\ = {arg max}_{i} \frac{P ( {lang}_{i} ) \cdot P ( word \vert {lang}_{i} )}{P ( word )} & suppose P ( word ) a nd P ( {lang}_{i} ) and constant \\ = {arg max}_{i} P ( word \vert {lang}_{i} ) & \end{matrix} \qquad ( 2 )$$

where 0<i≦LangS. A baseline NN-LID scheme is shown in FIG. 3. In FIG. 3, the alphabet set is at least the union of language-dependent sets for all languages supported by the NN-LID scheme.

Thus, when the number of languages increases, the size of the entire alphabet set (AlphaS) grows accordingly, and the LID model size (MemS) is proportionally increased. The increase in the alphabet size is due to the addition of special characters of the languages. For example, in addition to the standard Latin a-z alphabet, French has the special characters à, â, ç, é, ê, ë, î, ï, ô, ö, ù, û, ü; Portuguese has the special characters à, á, â, ã, ç, é, ê, í, ò, ó, ô, õ, ù, ü; and Spanish has the special characters á, è, ì, ñ, ó, ù, ü, and so on. Moreover, Cyrillic languages have a Cyrillic alphabet that differs from the Latin alphabet.

Compared with a normal PC environment, the implementation resources in embedded systems are sparse both in terms of processing power and memory. Accordingly, a compact implementation of the ASR engine is essential in an embedded system such as a mobile phone. Most of prior art methods carry out language identification from speech input. These methods cannot be applied to a system operating on text input only. Currently, an NN-LID system that can meet the memory requirements set by target hardware is not available.

It is thus desirable and advantageous to provide an NN-LID method and device that can meet the memory requirements set by target hardware, so that the method and system can be used in an embedded system.

### SUMMARY OF THE INVENTION

It is a primary objective of the present invention to provide a method and device for language identification in a multilingual speech recognition system, which can meet the memory requirements set by a mobile phone. In particular, language identification is carried out by a neural-network based system from written text. This objective can be achieved by using a reduced set of alphabet characters for neural-network based language identification purposes, wherein the number of alphabet characters in the reduced set is significantly smaller than the number of characters in the union set of language-dependent sets of alphabet characters for all languages to be identified. Furthermore, a scoring system, which relies on all of the individual language-dependent sets, is used to compute the probability of the alphabet set of words given the language. Finally, language identification is carried out by combining the language scores provided by the neural network with the probabilities of the scoring system.

Thus, according to the first aspect of the present invention, there is provided a method of identifying a language of a string of alphabet characters among a plurality of languages based on an automatic language identification system, each language having an individual set of alphabet characters. The method is characterized by

mapping the string of alphabet characters into a mapped string of alphabet characters selected from a reference set of alphabet characters,

obtaining a first value indicative of a probability of the mapped string of alphabet characters being each one of said plurality of languages,

obtaining a second value indicative of a match of the alphabet characters in the string in each individual set, and

deciding the language of the string based on the first value and the second value.

Alternatively, the plurality of languages is classified into a plurality of groups of one or more members, each group having an individual set of alphabet characters, so as to obtain the second value indicative of a match of the alphabet characters in the string in each individual set of each group.

The method is further characterized in that

the number of alphabet characters in the reference set is smaller than the union set of said all individual sets of alphabet characters.

Advantageously, the first value is obtained based on the reference set, and the reference set comprises a minimum set of standard alphabet characters such that every alphabet character in the individual set for each of said plurality of languages is uniquely mappable to one of the standard alphabet characters.

Advantageously, the reference set further comprises at least one symbol different from the standard alphabet characters, so that each alphabet character in at least one individual set is uniquely mappable to a combination of said at least one symbol and one of said standard alphabet characters.

Preferably, the automatic language identification system is a neural-network based system.

Preferably, the second value is obtained from a scaling factor assigned to the probability of the string given one of said plurality of languages, and the language is decided based on the maximum of the product of the first value and the second value among said plurality of languages.

According to the second aspect of the present invention, there is provided a language identification system for identifying a language of a string of alphabet characters among a plurality of languages, each language having an individual set of alphabet characters. The system is characterized by:

a reference set of alphabet characters,

a mapping module for mapping the string of alphabet characters into a mapped string of alphabet characters selected from the reference set for providing a signal indicative of the mapped string,

a first language discrimination module, responsive to the signal, for determining the likelihood of the mapped string being each one of said plurality of languages based on the reference set for providing first information indicative of the likelihood,

a second language discrimination module for determining the likelihood of the string being each one of said plurality of languages based on the individual sets of alphabet characters for providing second information indicative of the likelihood, and

a decision module, responding to the first information and second information, for determining the combined likelihood of the string being one of said plurality of languages based on the first information and second information.

Alternatively, the plurality of languages classified into a plurality of groups of one or more members, each of said plurality of groups having an individual set of alphabet characters, so as to allow the second language discrimination module to determine the likelihood of the string being each one of said plurality of languages based on the individual sets of alphabet characters of the groups for providing second information indicative of the likelihood.

Preferably, the first language discrimination module is a neural-network based system comprising a plurality of hidden units, and the language identification system comprises a memory unit for storing the reference set in multiplicity based partially on said plurality of hidden units, and the number of hidden units can be scaled according to the memory requirements. Advantageously, the number of hidden units can be increased in order to improve the performance of the language identification system.

According to the third aspect of the present invention, there is provided an electronic device, comprising:

a module for providing a signal indicative a string of alphabet characters in the device;

a language identification system, responsive to the signal, for identifying a language of the string among a plurality of languages, each of said plurality of languages having an individual set of alphabet characters, wherein the system comprises:

a reference set of alphabet characters;

a mapping module for mapping the string of alphabet characters into a mapped string of alphabet characters selected from the reference set for providing a further signal indicative of the mapped string;

a first language discrimination module, responsive to the further signal, for determining the likelihood of the mapped string being each one of said plurality of languages based on the reference set for providing first information indicative of the likelihood;

a second language discrimination module, responsive to the string, for determining the likelihood of the string being each one of said plurality of languages based on the individual sets of alphabet characters for providing second information indicative of the likelihood;

a decision module, responding to the first information and second information, for determining the combined likelihood of the string being one of said plurality of languages based on the first information and second information.

The electronic device can be a hand-held device such as a mobile phone.

The present invention will become apparent upon reading the description taken in conjunction with FIGS. 4-6.

### BRIEF DESCRIPTION OF THE DRAWINGS

FIG. 1 is schematic representation illustrating the architecture of a prior art multilingual ASR system.

FIG. 2 is schematic representation illustrating the architecture of a prior art two-layer neural network.

FIG. 3 is a block diagram illustrating a baseline NN-LID scheme in prior art.

FIG. 4 is a block diagram illustrating the language identification scheme, according to the present invention.

FIG. 5 is a flowchart illustrating the language identification method, according to the present invention.

FIG. 6 is a schematic representation illustrating an electronic device using the language identification method and system, according to the present invention.

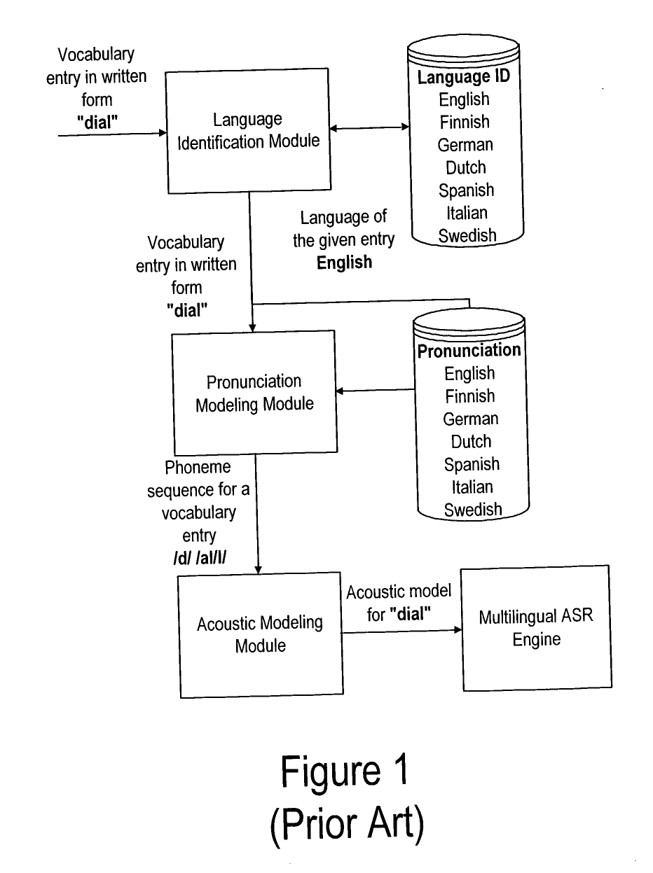

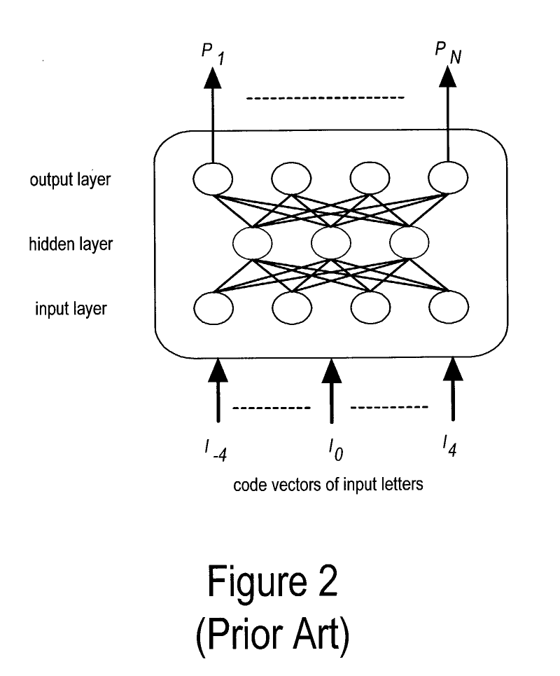

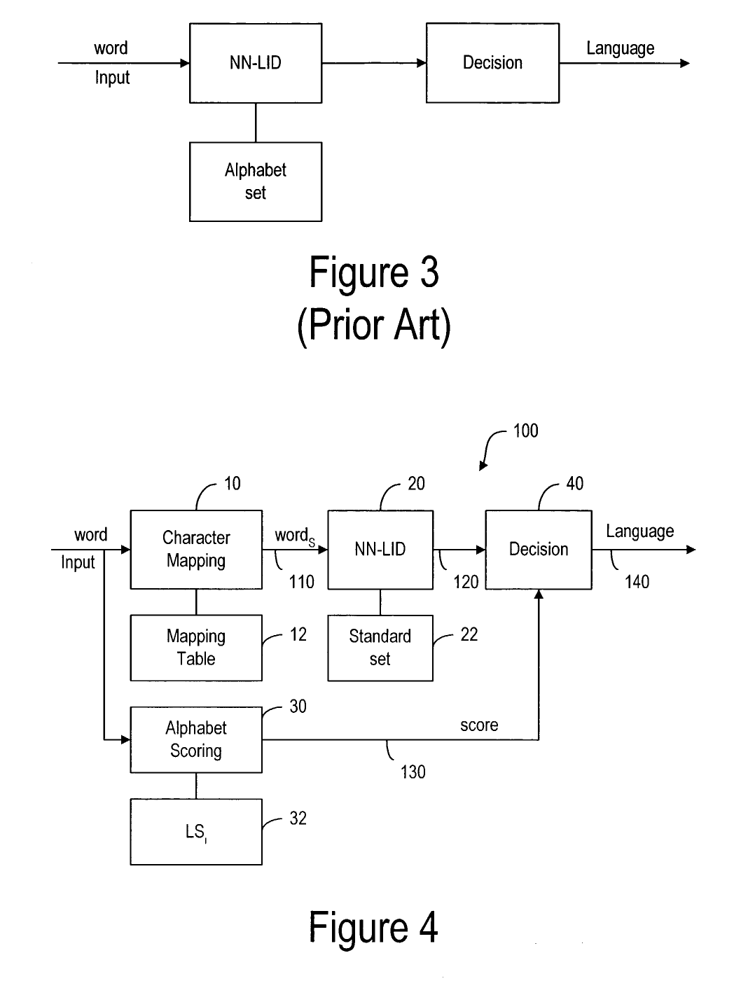

### DETAILED DESCRIPTION OF THE INVENTION

As can be seen in Equation (1), the memory size of a neural-network based language identification (NN-LID) system is determined by two terms. 1) (2*ContS+1)×AlphaS×HiddenU, and 2) HiddenU×LangS, where ContS, AlphaS, HiddenU and LangS stand for context size, size of alphabet set, number of hidden units in the neural network and the number of languages supported by LID. In general, the number of languages supported by LID, or LangS, does not increase faster than the size of alphabet set, and the term (2*ContS+1) is much larger than 1. Thus, the first term of Equation (1) is clearly dominant. Furthermore, because LangS and ContS are predefined, and Hidden U controls the discriminative capability of LID system, the memory size is mainly determined by AlphaS. AlphaS is the size of the language-independent set to be used in the NN-LID system.

The present invention reduces the memory size by defining a reduced set of alphabet characters or symbols, as the standard language-independent set SS to be used in the NN-LID. SS is derived from a plurality of language-specific or language-dependent alphabet sets, LSᵢ, where 0<i<LangS and LangS is the number of languages supported by the LID. With LSi being the i^{th} language-dependent and SS being the standard set, we have

LSᵢ={c_{i,1}, c_{i,2}, . . . , c_{i,ni}}; i=1, 2, . . . , LangS (3)

SS={s₁, s₂, . . . , s_{M}}; (4)

where c_{i,k}, and sₖ are the k^{th} characters in the i^{th} language-dependent and the standard alphabet sets. ni and M are the sizes of the i^{th} language-dependent and the standard alphabet sets. It is understood that the union of all of the language-dependent alphabet sets retains all the special characters in each of the supported languages. For example, if Portuguese is one of the languages supported by LID, then the union set at least retains these special characters: à, á, â, ã, [symbol] , é, ê, í, ò, ó, ô, õ, ú, ü. In the standard set, however, some or all of the special characters are eliminated in order to reduce the size M, which is also AlphaS in Equation (1).

In the NN-LID system, according to the present invention, because the standard set SS is used, instead of the union of all language-dependent sets, a mapping procedure must be carried out. The mapping from the language-dependent set to the standard set can be defined as:

c_{i,k}→sⱼ C_{i,k}εLSᵢ, sⱼεSS, ∀c_{i,k} (5)

$$∃ word = {x}_{1} {x}_{2} ⋯ {x}_{c} , {x}_{1} {x}_{2} ⋯ {x}_{c} \to {y}_{1} {y}_{2} ⋯ {y}_{c} ( = {word}_{s} ) {x}_{j} ∈ {{⋃}_{i = 1}}^{N} {LS}_{i} , {y}_{j} ∈ SS \qquad ( 6 )$$

The alphabet size is reduced from size of

$${{⋃}_{i = 1}}^{N} {LS}_{i}$$

to M (size of SS). For mapping purposes, a mapping table for mapping alphabet characters from every language to the standard set can be used, for example. Alternatively, a mapping table that maps only special characters from every language to the standard set can be used. The standard set SS can be composed of standard characters such as {a, b, c, . . . , z} or of custom-made alphabet symbols or the combination of both.

It is understood from Equation (6) that any word written with the language-dependent alphabet set can be mapped (decomposed) to a corresponding word written with the standard alphabet set. For example, the word häkkinen written with the language-dependent alphabet set is mapped to the word hakkinen written with the standard set. Hereafter, the word such as häkkinen written with language-dependent alphabet set is referred to as a word, and the corresponding word hakkinen written with the standard set is referred to as a wordₛ.

Given the language-dependent set and a words written with the standard set, a word written with the language-dependent set is approximately determined. Therefore we could reasonably assume:

(word) [symbol] (wordᵢ, alphabet) (7)

Here alphabet is the individual alphabet letters in word. Since wordₛ, and alphabet are independent events, Equation (2) can be re-written as

$$\begin{matrix}{lang}^{*} = {arg max }_{i} P ( word \vert {lang}_{i} ) \\ = {arg max }_{i} P ( {word}_{s} , alphabet \vert {lang}_{i} ) \\ = {arg max }_{i} P ( {word}_{s} \vert {lang}_{i} ) \cdot P ( alphabet \vert {lang}_{i} )\end{matrix} \qquad ( 8 )$$

The first item on the right side of Equation (8) is estimated by using NN-LID. Because LID is made on wordₛ instead of word, it is sufficient to use the standard alphabet set, instead of

$${{⋃}_{i = 1}}^{N} {LS}_{i} ,$$

the union of all language-dependent sets. The standard set consists of “minimum” number of characters, and thus its size M is much smaller than the size of

$${{⋃}_{i = 1}}^{N} {LS}_{i} .$$

From Equation (1), it can be seen that the size of NN-LID model is reduced because AlphaS is reduced. For example, when 25 languages, including Bulgarian, Czech, Danish, Dutch, Estonian, Finnish, French, German, Greek, Hungarian, Icelandic, Italian, Latvian, Norwegian, Polish, Portuguese, Romanian, Russian, Slovakian, Slovenian, Spanish, Swedish, Turkish, English, and Ukrainian are included in the NN-LID scheme, the size of the union set is 133. In contrast, the size of the standard set can be reduced to 27 of ASCII alphabet set.

The second item on the right side of Equation (8) is the probability of the alphabet string of word given the i^{th} language. For finding the probability of the alphabet string, we can first calculate the frequency, Freq(x), as follows:

$$Freq ( alphabet \vert {lang}_{i} ) = \frac{\begin{matrix}number of matched letters in \\ alphabetic set of ith language for word\end{matrix}}{number of letters in word} \qquad ( 9 )$$

Then the probability of P(alphabet|langᵢ) can be computed. This alphabet probability can be estimated by either hard or soft decision.

For hard decision, we have

$$P ( alphabet \vert {lang}_{i} ) = \{ \begin{matrix}1 , & if Freq ( alphabet \vert {lang}_{i} ) = 1 \\ 0 , & if Freq ( alphabet \vert {lang}_{i} ) < 1\end{matrix} \qquad ( 10 )$$

For soft decision, we have

$$P ( alphabet \vert {lang}_{i} ) = \{ \begin{matrix}1 , & if Freq ( alphabet \vert {lang}_{i} ) = 1 \\ α \cdot Freq ( alphabet \vert {lang}_{i} ) , & if Freq ( alphabet \vert {lang}_{i} ) < 1\end{matrix} \qquad ( 11 )$$

Since the multilingual pronunciation approach needs n-best LID decisions for finding multilingual pronunciations, and hard decision sometimes cannot meet that need, soft decision is preferred. The factor α is used to further separate the matched and unmatched languages into two groups.

The factor α can be selected arbitrarily. Basically, any small value like 0.05 can be used. As seen from Equation (1), the NN-LID model size is significantly reduced. Thus, it is even possible to add more hidden units to enhance the discriminative capability. Taking the Finnish name “hakkinen” as an example, we have

$$\begin{matrix}Freq ( alphabet \vert English ) = \frac{7}{8} = 0.88 \\ Freq ( alphabet \vert Finnish ) = \frac{8}{8} = 1.0 \\ Freq ( alphabet \vert Swedish ) = \frac{8}{8} = 1.0 \\ Freq ( alphabet \vert Russian ) = \frac{0}{8} = 0.0\end{matrix}$$

With α=0.05 for Freq (alphabet|langᵢ)<1, we have the following alphabet scores:

P(alphabet|English)=0.04

P(alphabet|Finnish)=1.0

P(alphabet|Swedish)=1.0

P(alphabet|Russian)=0.0

It should be noted that the probability P(wordₛ|langᵢ) is determined differently than the probability P(alphabet|langᵢ). While the former is computed based on the standard set SS, the latter is computed based on every individual language-dependent set LSᵢ. Thus, the decision making process comprises two independent steps which can be carried out simultaneously or sequentially. These independent, decision-making process steps can be seen in FIG. 4, which is a schematic representation of a language identification system 100, according to the present invention. As shown, responding to the input word, a mapping module 10, based on a mapping table 12, provides information or signal 110 indicative to the mapped wordₛ to the NN-LID module 20. Responding to the signal 110, the NN-LID module 20 computes the probability P(wordₛ|langᵢ), based on the standard set 22, and provides information or a signal 120 indicative of the probability to a decision making module 40. Independently, an alphabet scoring module 30 computes the probability P(alphabet|langᵢ), using the individual language-dependent sets 32, and provides information or a signal 130 indicative of the probability to the decision making module 40. The language of the input word, as identified by the decision-making module 40, is indicated as information or signal 140.

According to the present invention, the neural-network based language identification is based on a reduced set having a set size M. M can be scaled according to the memory requirements. Furthermore, the number of hidden units HiddenU can be increased to enhance the NN-LID performance without exceeding the memory budget.

As mentioned above, the size of the NN-LID model is reduced when all of the language-dependent alphabet sets are mapped to the standard set. The alphabet score is used to further separate the supported languages into the matched and unmatched groups based on the alphabet definition in word. For example, if letter “ö” appears in a given word, this word belongs to the Finnish/Swedish group only. Then NN-LID identifies the language only between Finnish and Swedish as a matched group. After LID on the matched group, it then identifies the language on the unmatched group. As such, the search space can be minimized. However, confusion arises when the alphabet set for a certain language is the same or close to the standard alphabet set due to the fact that more languages are mapped to the standard set. For example, we originally define the standard alphabet set SS={a, b, c, . . . , z, #}, where “#” stands for null character, so the size of the standard alphabet set is 27. For the word that represents the Russian name “ [symbol] ”, (mapping can be like “ [symbol] ->b”, etc), the corresponding mapped name is the words “boris” on SS. This could undermine the performance of NN-LID based on the standard set, because the name “boris” appears to be German or even English.

In order to overcome this drawback, it is possible to increase the number of hidden units to enhance the discriminative power of the neural network. Moreover, it is possible to map one non-standard character in a language-dependent set to a string of characters in the standard set. As such, the confusion in the neural network is reduced. Thus, although the mapping to the standard set reduces the alphabet size (weakening discrimination), the length of the word is increased due to single-to-string mapping (gaining discrimination). Discriminative information is kept almost the same after such single-to-string transform. By doing so, discriminative information is transformed from the original representation by introducing more characters to enlarge the word length as described by

c_{i,k}→sⱼ₁sⱼ₂ . . . c_{i,k}εLSᵢ, sⱼᵢεSS, ∀c_{i k} (12)

By this transform, a non-standard character can be represented by the string of standard characters without significantly increasing confusion. Furthermore, the standard set can be extended by adding a limited number of custom-made characters defined as discriminative characters. In our experiment, we define three discriminative characters. These discriminative characters are distinguishable from the 27 characters in the previously defined standard alphabet set SS={a, b, c, . . . , z, #}. For example, the extended standard set additionally includes three discriminative characters S1, S2, S3, and now SS={a, b, c, . . . , z, S1, S2, s3}. As such, it is possible to map one non-standard character to a string of characters in the extended standard set. For example, the mapping of Cyrillic characters can be carried out such as “ [symbol] ->bs₁”. The Russian name “ [symbol] ” is mapped according to

[symbol]

->bs₁os₁rs₁is₁ss₁

With this approach, not only can the performance in identifying Russian text be improved, but the performance in identifying English text can also be improved due to reduced confusion.

We have conducted experiments on 25 languages including Bulgarian, Czech, Danish, Dutch, Estonian, Finnish, French, German, Greek, Hungarian, Icelandic, Italian, Latvian, Norwegian, Polish, Portuguese, Romanian, Russian, Slovakian, Slovenian, Spanish, Swedish, Turkish, English, and Ukrainian. For each language, a set of 10,000 general words was chosen, and the training data for LID was obtained by combining these sets. The standard set consisted of an [a-z] set, null character (marked as ASCII in TABLE III) plus three discriminative characters (marked as EXTRA in TABLE III). The number of the standard alphabet characters or symbols is 30. TABLE II gives the baseline result when the whole language-dependent alphabet is used (total of 133) with 30 and 40 hidden units. As shown in TABLE II, the memory size for the baseline NN-LID model is already large when 30 hidden units are used in the baseline NN-LID system.

TABLE III shows the result of the NN-LID scheme, according to the present invention. It can be seen that the NN-LID result, according to the present invention, is inferior to the baseline result when the standard set of 27 characters is used along with 40 hidden units. By adding three discriminative characters so that the standard set is extended to include 30 characters, the LID rate is only slightly lower than the baseline rate—the sum of 88.78 versus the sum of 89.93. However, the memory size is reduced from 47.7 KB to 11.5 KB. This suggests that it is possible to increase the number of hidden units by a large amount in order to enhance the LID rate.

When the number of hidden units is increased to 80, the LID rate of the present invention is clearly better than the baseline rate. With the standard set of 27 ASCII characters, the LID rate for 80 hidden units already exceeds that of the baseline scheme—90.44 versus 89.93. With the extended set of 30 characters, the LID is further improved while saving over 50% of memory as compared to the baseline scheme with 40 hidden units.

TABLE II

| Setup, 25Lang, | | | | 4th- | Sum | Mem |
|---|---|---|---|---|---|---|
| AlphaSize:133 | 1st-best | 2nd-best | 3rd-best | best | (4th best) | (KB) |
| 40 hu | 67.81 | 12.32 | 6.12 | 3.69 | 89.93 | 47.7 |
| 30 hu | 65.25 | 12.82 | 6.31 | 4.11 | 88.49 | 35.8 |

TABLE III

| Setup, 25Lang | | | | 4th- | Sum | Mem |
|---|---|---|---|---|---|---|
| Alpha Scoring | 1st-best | 2nd-best | 3rd-best | best | (4th best) | (KB) |
| ASCII, 40 hu | 57.36 | 17.67 | 8.13 | 4.61 | 87.77 | 10.5 |
| AlphaSize:27 | | | | | | |
| ASCII, 80 hu | 65.59 | 13.94 | 6.85 | 4.06 | 90.44 | 20.9 |
| AlphaSize:27 | | | | | | |
| ASCII + Extra, | 64.16 | 14.14 | 6.45 | 4.03 | 88.78 | 11.5 |
| 40 hu Alpha | | | | | | |
| Size:30 | | | | | | |
| ASCII + Extra, | 71.01 | 11.98 | 5.44 | 3.30 | 91.73 | 23 |
| 80 hu Alpha | | | | | | |
| Size:30 | | | | | | |

The scalable NN-LID scheme, according to the present invention, can be implemented in many different ways. However, one of the most important features is the mapping of language-dependent characters to a standard alphabet set that can be customized. For further enhancing the NN-LID performance, a number of techniques can be used. These techniques include: 1) adding more hidden units, 2) using information provided by language-dependent characters for grouping the languages into a matched group and an unmatched group, 3) mapping a character to a string, and 4) defining discriminative characters.

The memory requirements of the NN-LID can be scaled to meet the target hardware requirements by the definition of the language-dependent character mapping to a standard set, and by selecting the number of hidden units of the neural network suitably so as to keep LID performance close to the baseline system.

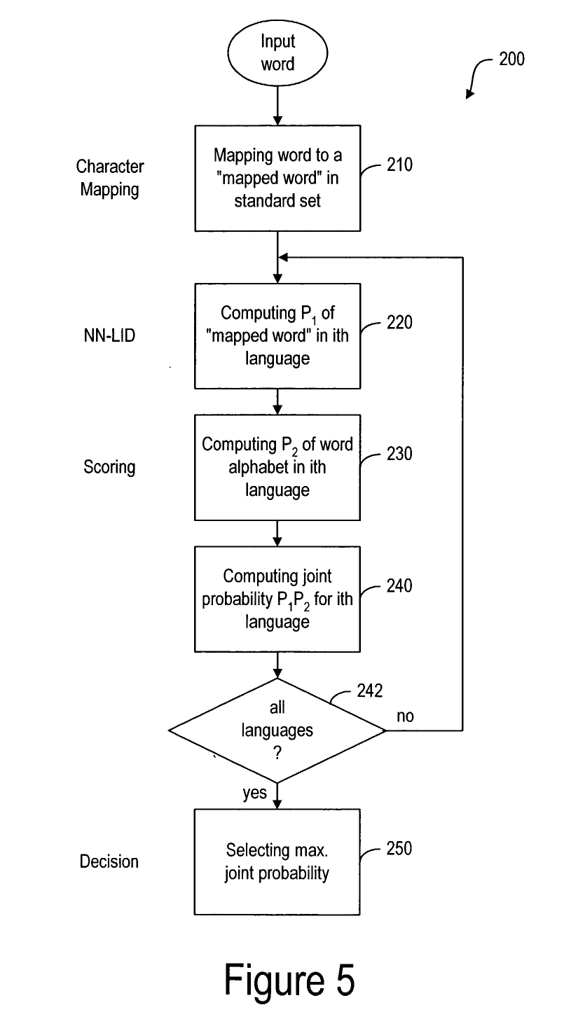

The method of scalable neural network-based language identification from written text, according to the present invention, can be summarized in the flowchart 200, as shown in FIG. 5. After obtaining a word in written text, the word is mapped into a wordₛ, or a string of alphabet characters of a standard set SS at step 210. At step 220, the probability P(wordₛ|langᵢ) is computed for the i^{th} language. At step 230, the probability P(alphabet|langᵢ) is computed for the i^{th} language. At step 240, the joint probability P(wordₛ|langᵢ)∀P(alphabet|langᵢ) is computed for the i^{th} language. After the joint probability in each of the supported languages is computed, as determined at step 242, the language of the input word is decided at step 250 using Equation 8.

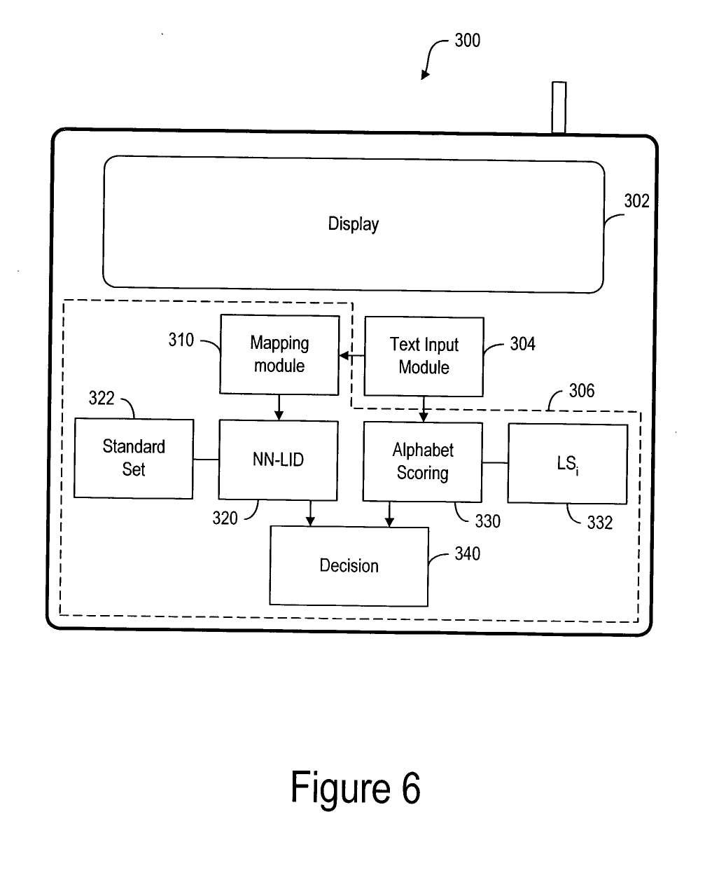

The method of scalable neural network-based language identification from written text, according to the present invention, is applicable to multilingual automatic speech recognition (ML-ASR) system. It is an integral part of a multilingual speaker-independent name dialing (ML-SIND) system. The present invention can be implemented on a hand-held electronic device such as a mobile phone, a personal digital assistant (PDA), a communicator device and the like. The present invention does not rely on any specific operation system of the device. In particular, the method and device of the present invention are applicable to a contact list or phone book in a hand-held electronic device. The contact list can also be implemented in an electronic form of business card (such as vCard) to organize directory information such as names, addresses, telephone numbers, email addresses and Internet URLs. Furthermore, the automatic language identification method of the present invention is not limited to the recognition of names of people, companies and entities, but also includes the recognition of names of streets, cities, web page addresses, job titles, certain parts of an email address, and so forth, so long as the string of characters has a certain meaning in a certain language. FIG. 6 is a schematic representation of a hand-held electronic device where the ML-SIND or ML-ASR using the NN-LID scheme of the present invention is used.

As shown in FIG. 6, some of the basic elements in the device 300 are a display 302, a text input module 304 and an LID system 306. The LID system 306 comprises a mapping module 310 for mapping a word provided by the text input module 302 into a wordₛ using the characters of the standard set 322. The LID system 306 further comprises an NN-LID module 320, an alphabet-scoring module 330, a plurality of language-dependent alphabet sets 332 and a decision module 340, similar to the language-identification system 100 as shown in FIG. 4.

It should be noted that while the orthogonal letter coding scheme, as shown in TABLE I, is preferred, other coding methods can also be used. For example a self-organizing codebook can be utilized. Furthermore, a string of two characters has been used in our experiment to map a non-standard character according to Equation (12). In addition, a string of three or more characters or symbols can be used.

It should be noted that, among the languages used in the neural network-based language identification system of the present invention, it is possible that two or more languages share the same set of alphabet characters. For example, in the 25 languages that have been used in the experiments, Swedish and Finnish share the same set of alphabet characters, so do Danish and Norwegian. Accordingly, the number of different language-dependent sets is smaller than the number of languages to be identified. Thus, it is possible to classify the languages into language groups based on the sameness of the language-dependent set. Among these groups, some have two or more members, but some have only one member. Depending on the languages used, it is possible that no two languages share the same set of alphabet characters. In that case, the number of groups will be equal to the number of languages, and each language group has only one member.

Thus, although the invention has been described with respect to a preferred embodiment thereof, it will be understood by those skilled in the art that the foregoing and various other changes, omissions and deviations in the form and detail thereof may be made without departing from the scope of this invention.

What is claimed is:

1. A method of identifying a language of a string of alphabet characters among a plurality of languages based on an automatic language identification system, each said plurality of languages having an individual set of alphabet characters, said method characterized by
mapping the string of alphabet characters into a mapped string of alphabet characters selected from a reference set of alphabet characters,
obtaining a first value indicative of a probability of the mapped string of alphabet characters being each one of said plurality of languages,
obtaining a second value indicative of a match of the alphabet characters in the string in each individual set, and
deciding the language of the string based on the first value and the second value.

2. The method of claim 1, further characterized in that
the number of alphabet characters in the reference set is smaller than the union set of said all individual sets of alphabet characters.

3. The method of claim 1, characterized in that the first value is obtained based on the reference set.

4. The method of claim 3, characterized in that the reference set comprises a minimum set of standard alphabet characters such that every alphabet character in the individual set for each of said plurality of languages is uniquely mappable to one of the standard alphabet characters.

5. The method of claim 3, characterized in that the reference set consists of a minimum set of standard alphabet characters and a null symbol, such that every alphabet character in the individual set for each of said plurality of languages is uniquely mappable to one of said standard alphabet characters.

6. The method of claim 5, characterized in that the number of alphabet characters in the mapped string is equal to the number of the alphabet characters in the string.

7. The method of claim 4, characterized in that the reference set comprises the minimum set of standard alphabet characters and at least one symbol different from the standard alphabet characters, so that each alphabet characters in at least one individual set is uniquely mappable to a combination of one of said standard alphabet characters and said at least one symbol.

8. The method of claim 4, characterized in that the reference set comprises the minimum set of standard alphabet characters and a plurality of symbols different from the standard alphabet characters, so that each alphabet characters in at least one individual set is uniquely mappable to a combination of said standard alphabet characters and said at least one of said plurality of symbols.

9. The method of claim 8, characterized in that the number of symbols is adjustable according to a desired performance of the automatic language identification system.

10. The method of claim 1, characterized in that the automatic language identification system is a neural-network based system comprising a plurality of hidden units, and that the number of the hidden units is adjustable according to a desired performance of the automatic language identification system.

11. The method of claim 3, characterized in that the automatic language identification system is a neural-network based system and the probability is computed by the neural-network based system.

12. The method of claim 1, characterized in that the second value is obtained from a scaling factor assigned to a probability of the string given one of said plurality of languages.

13. The method of claim 12, characterized in that the language is decided based on the maximum of the product of the first value and the second value among said plurality of languages.

14. A method of identifying a language of a string of alphabet characters among a plurality of languages based on an automatic language identification system, said plurality of languages classified into a plurality of language groups, each group having an individual set of alphabet characters, said method characterized by
mapping the string of alphabet characters into a mapped string of alphabet characters selected from a reference set of alphabet characters, by
obtaining a first value indicative of a probability of the mapped string of alphabet characters being each one of said plurality of languages,
obtaining a second value indicative of a match of the alphabet characters in the string in each individual set, and
deciding the language of the string based on the first value and the second value.

15. The method of claim 14, further characterized in that
the number of alphabet characters in the reference set is smaller than the union set of said all individual sets of alphabet characters.

16. The method of claim 14, characterized in that the first value is obtained based on the reference set.

17. A language identification system for identifying a language of a string of alphabet characters among a plurality of languages, each of said plurality of languages having an individual set of alphabet characters, said system characterized by:
a reference set of alphabet characters,
a mapping module for mapping the string of alphabet characters into a mapped string of alphabet characters selected from the reference set for providing a signal indicative of the mapped string,
a first language discrimination module, responsive to the signal, for determining the likelihood of the mapped string being each one of said plurality of languages based on the reference set for providing first information indicative of the likelihood,
a second language discrimination module, for determining the likelihood of the string being each one of said plurality of languages based on the individual sets of alphabet characters for providing second information indicative of the likelihood, and
a decision module, responsive to the first information and second information, for determining the combined likelihood of the string being one of said plurality of languages based on the first information and second information.

18. The system of claim 17, further characterized in that
the number of alphabet characters in the reference set is smaller than the union set of said all individual sets of alphabet characters.

19. The language identification system of claim 17, characterized in that
the first language discrimination module is a neural-network based system comprising a plurality of hidden units, and the language identification system comprises a memory unit for storing the reference set in multiplicity based partially on said plurality of hidden units, and that
the number of hidden units can be scaled according to the size of the memory unit.

20. The language identification system of claim 17, characterized in that
the first language discrimination module is a neural-network based system comprising a plurality of hidden units, and that
the number of hidden units can be increased in order to improve the performance of the language identification system.

21. An electronic device, comprising:
a module for providing a signal indicative of a string of alphabet characters;
a language identification system, responsive to the signal, for identifying a language of the string among a plurality of languages, each of said plurality of languages having an individual set of alphabet characters, the system characterized by
a reference set of alphabet characters;
a mapping module for mapping the string of alphabet characters into a mapped string of alphabet characters selected from the reference set for providing a further signal indicative of the mapped string;
a first language discrimination module, responsive to the further signal, for determining the likelihood of the mapped string being each one of said plurality of languages based on the reference set for providing first information indicative of the likelihood;
a second language discrimination module, responsive to the first signal, for determining the likelihood of the string being each one of said plurality of languages based on the individual sets of alphabet characters for providing second information indicative of the likelihood;
a decision module, responding to the first information and second information, for determining the combined likelihood of the string being one of said plurality of languages based on the first information and second information.

22. The device of claim 21, wherein the number of alphabet characters in the reference set is smaller than the union set of said all individual sets of alphabet characters.

24. The electronic device of claim 21, comprising a hand-held device.

25. The electronic device of claim 21, comprising a mobile phone.
